(19) United States
(12) Patent Application Publication
(10) Pub. No.: US 2004/0094644 A1
(43) Pub. Date: May 20, 2004

(54) Jaw crusher unit

(76) Inventors: Paul Douglas, Swadlincote (GB); Terence Bartton, Swadlincote (GB)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/399,968

(22) PCT Filed: Oct. 16, 2001
(86) PCT No.: PCT/GB01/04597

(30) Foreign Application Priority Data
Oct. 23, 2000 (GB) 0025888.9

(51) Int. Cl. B02C 1/04

(52) U.S. Cl. 241/268

(57) ABSTRACT

A jaw crusher unit for use in crushing stone and other crushable material having a fixed jaw and a movable jaw which define a crushing zone therebetween. A drive mechanism coupled with the movable jaw is operative to rock the movable jaw to and fro in order to crush material in the crushing zone. A link mechanism connected to a lower end of the movable jaw serves to set any required space between the lower end of the movable jaw and thereby control the discharge of crushed material from the lower end of the crushing zone. The link mechanism includes a pressure-medium controlled toggle mechanism which is automatically adjustable to compensate for wear.

This invention relates to a jaw crusher unit for use in crushing stone and other crushable material and comprising a fixed jaw and a movable jaw which define a crushing zone therebetween, and a drive mechanism operative to rock tile movable jaw to and fro in order to crush material in the crushing zone.

The crushing zone defined between the fixed jaw and the movable jaw is usually generally convergent towards its lower discharge end, so that crushable material can be fed to the upper and wider end of the zone, and then fall downwardly under gravity while being subjected to repeated cycles of crushing movement and relieving movement of the movable jaw. This breaks down the material, and crushed material finally falls under gravity through the narrower lower discharge end of the crushing zone.

In existing machines the drive mechanism usually takes the form of an eccentric drive mechanism, and the “throw” of the mechanism has an influence on the crushing action, and so also has the width of the crushing zone at the lower discharge end.

It is therefore usual to provide an adjustable link mechanism which is connected to a lower end of the movable jaw, and which can be adjusted in order to set any required spacing apart of the lower end of the movable jaw from the lower end of the fixed jaw. Known link mechanisms are entirely mechanical, and include spring-loaded link arms, and suffer from two disadvantages. First of all, in the event of wearing of the wear plates and the like usually carried by the jaws, it is necessary for the known crusher unit to be shut down while manual adjustment are made to compensate for such wear. Secondly, in that spring loaded mechanisms are utilised, there is risk of failure over a period of time due to fatigue stresses being generated.

The present invention therefore seeks to provide a novel link mechanism which is automatically adjustable to compensate for wear.

According to the invention there is provided a jaw crusher unit for use in crushing stone and other crushable material and comprising a fixed jaw and a movable jaw which define a crushing zone therebetween, a drive mechanism coupled with the movable jaw and operative to rock the movable jaw to and fro in order to crush material in the crushing zone, and a link mechanism connected to a lower end of the movable jaw and serving to set any required space between the lower end of the movable jaw and the fixed jaw and thereby control the discharge of crushed material from the lower end of the crushing zone, in which the link mechanism includes a pressure-medium controlled toggle mechanism which is automatically adjustable to compensate for wear.

Preferably, the toggle mechanism is hydraulically controlled.

The toggle mechanism therefore is able to set a required size of the discharge end of the crushing zone, and under hydraulic control is able to adjust itself automatically to compensate for wear (e.g. of wear plates on the jaws and/or toggle wear generally). This avoids the present necessity in existing arrangements for manual adjustments to be made. which require the operation of the crusher unit to be shut down.

A further and preferred advantage of the toggle mechanism of the invention is that, in the event of an excessive load causing toggle failure, the toggle is able to break open and allow the lower end of the movable jaw to carry out relieving movement.

Preferably, a sensor arrangement is provided in a hydraulic control circuit (which normally maintains the toggle link under permanent compression), and which sends an immediate shut-down signal to stop the operation of the crusher unit. After the problem has been identified e.g. an excessively large piece of crushed material becoming trapped in a lower part of the crushing zone, and being removed, the mechanism can easily be re-set so that operation can resume.

In a preferred arrangement, the toggle mechanism comprises an arrangement of a pair of link arms, and corresponding pressure cylinders associated therewithin.

A preferred embodiment of jaw crusher unit according to the invention will now be described in detail, by way of example only, with reference to the accompanying drawings, in which:

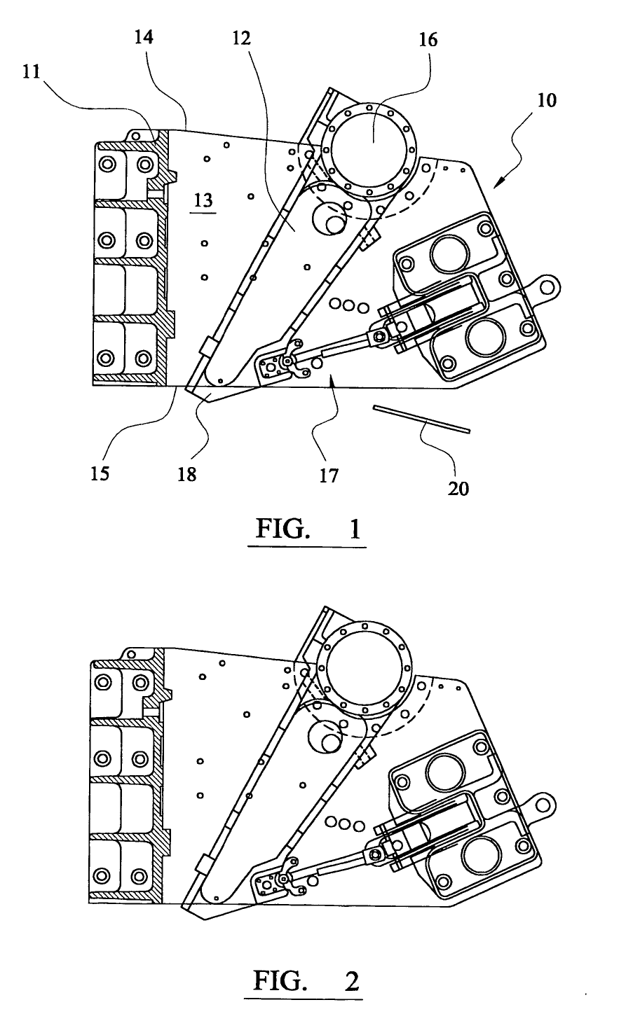

FIG. 1 is a side view showing the co-operation between a fixed jaw and a movable jaw of the crusher unit, and also showing a hydraulically controlled toggle linkage coupled with a lower end of the movable jaw;

FIG. 2 is a view, similar to FIG. 1, showing further detail of the components of the toggle mechanism;

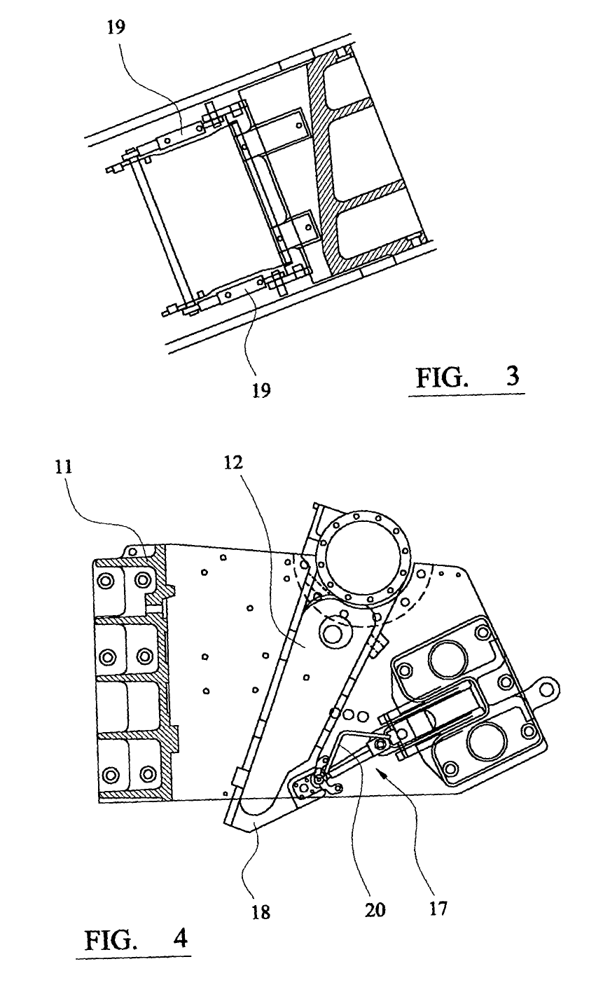

FIG. 3 is a plan view showing two toggle linkage arms and associated pressure cylinders of the toggle mechanism in more detail; and,

FIG. 4 is a showing how the toggle mechanism reacts in the event of a toggle failure.

Referring now to the drawings, a jaw crusher unit according to the invention is designated generally by reference 10 and is intended to crush stone or other crushable material. The unit 10 comprises a fixed jaw 11 and a movable jaw 12 which define a crushing zone 13 therebetween in which crushable material can be introduced via an upper and larger receiving end 14, and crushed material can be discharged downwardly under gravity via narrower and lower discharge end 15. A drive mechanism 16 is coupled with the movable jaw 12 and is operative to rock the movable jaw 12 to and fro in order to crush material in the crushing zone 13.

An automatically adjustable link mechanism, designated generally by reference 17, is connected to a lower end 18 of the movable jaw 12, and serves to set any required space (lower discharge end 15) between the lower end 18 of the movable jaw 12 and the fixed jaw 11, and thereby control the discharge of crushed material from the lower end of the crushing zone.

The link mechanism 17 takes the form of a pressure-medium controlled toggle mechanism which is automatically adjustable to compensate for wear. The preferred pressure-medium to control the operation of the toggle mechanism is hydraulic pressure. The toggle mechanism therefore is able to set a required size of the discharge end 15 of the crushing zone 13, and under hydraulic control is able to adjust itself automatically to compensate for wear. Wear which can arise over a period of time includes wear of the wear plates on the jaws, and/or toggle wear generally. The automatic adjustment therefore avoids the problem with existing mechanically operated mechanisms, which require manual adjustments to be made in the event of wear, which requires the operation of the crusher unit to be shut down.

Furthermore, in the event of an excessive load causing toggle failure, and as shown in FIG. 4, the toggle mechanism 17 is able to break open and allow the lower end 18 of the movable jaw to carry out relieving movement. A sensor arrangement (not shown in detail) is provided in a hydraulic control circuit, and which sends an immediate shut-down signal to stop operation of the crusher unit, when the toggle breaks open. After the problem has been identified, and overcome e.g. by removal of an excessively large piece of crushed material which has become trapped, the mechanism can easily be reset so that operation can resume.

FIG. 3 shows in more detail the construction of the toggle mechanism, and it comprises a pair of hydraulic link arms 19, each having a corresponding control cylinder associated therewith. The link arms 19 are therefore maintained constantly under compressive force during normal operation, and keep the toggle linkage located between the usual “back beam” and the jaw stock. The link arms 19 automatically adjust to toggle wear, and do not need regular adjustment which is required with current mechanical spring link arm system. The known mechanical spring link arm systems also suffer from fatigue failure, and this problem also is overcome by the embodiment of the invention.

FIG. 1 also shows that replacement of a toggle link can easily be carried out, by extension of the hydraulic link arm to facilitate removal, and replacement of toggle 20. FIG. 4 also shows the deformation of the toggle 20 in a failure mode.

1. A jaw crusher unit (10) for use in crushing stone and other crushable material and comprising a fixed jaw (11) and a movable jaw (12) which define a crushing zone (13) therebetween, a drive mechanism (16) coupled with the movable jaw (12) and operative to rock the movable jaw to and fro in order to crush material in the crushing zone, and a link mechanism (17) connected to a lower end (18) of the movable jaw (12) and serving to set any required space between the lower end (18) of the movable jaw (12) and thereby control the discharge of crushed material from the lower end of the crushing zone (13), in which the link mechanism includes a pressure-medium controlled toggle mechanism which is automatically adjustable to compensate for wear.

2. A jaw crusher unit according to claim 1, in which the toggle mechanism (17) is hydraulically controlled.

3. A jaw crusher unit according to claim 2, including a hydraulic control circuit provided with a sensor arrangement and which is operative normally to maintain the toggle link under permanent compression, and which is operative also, upon a predetermined increase in pressure in the control circuit, to send an immediate shut-down signal to stop the operation of the crusher unit.

4. A jaw crusher unit according to any one of claims 1 to 3, in which the toggle mechanism comprises an arrangement of a pair of link arms (19), each having a corresponding control cylinder associated therewith.

5. A jaw crusher unit according to any one of claims 1 to 4, in which the toggle mechanism is able to break open, in the event of an excessive load causing toggle failure, thereby to allow the lower end (18) of the movable jaw (12) to carry out relieving movement.
